(19) United States
(12) Patent Application Publication
(10) Pub. No.: US 2003/0190150 A1
(43) Pub. Date: Oct. 9, 2003

(54) Record/playback device and related computer program

(76) Inventors: Masahiro Kawasaki, Hiroshima-shi (JP); Tohru Suetomo, Hiroshima-shi (JP); Youichi Yamamoto, Hiroshima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/369,655

(22) Filed: Feb. 21, 2003

(30) Foreign Application Priority Data
Feb. 21, 2002 (JP) 2002-044171

(51) Int. Cl. H04N 5/76; G06F 3/00; G06F 13/00

(52) U.S. Cl. 386/83; 386/1; 725/58

(57) ABSTRACT

A disk device provided in a record/playback device stores a plurality of programs as well as a record-setting content and playback history of each program. When specified by a remote controller as to a program to be played from a program list displayed on a television screen, a serial judging unit judges whether the specified program is an episode in a serial having another episode that was recorded prior to the specified program, by comparing the record-setting content of each of the programs. If judged in the affirmative, a playback judging unit judges whether the other episode has yet to be played, by referring to the playback history of the other episode. If judged in the affirmative, a presentation unit has displayed on the television screen that there is an unplayed episode in the serial. Then, when instructed by a user to start the playback from the unplayed episode, a playback unit plays the unplayed episode.

### BACKGROUND OF THE INVENTION

1. Field of the Invention

The present invention relates to mass storage media such as DVD-RAM, DVD-RW and hard disks, and to record/playback devices for recording television programs and playing back (hereafter, simply “playing”) the TV programs in an arbitrary order by random access.

2. Related Art

Conventionally, record/playback devices for recording/playing TV programs (hereafter “programs”) use VHS video tape and other tape media as storage media. Operations such as rewinding the tape are thus required to playback from an arbitrary position, and as a result it is not easy to achieve prompt playback.

In contrast, record/playback devices that use disk storage media such as hard disks, DVD-RAM and DVD-RW have been appearing on the market in recent years. Prompt random access is possible using disk storage media such as these, and a list of the recorded programs can be displayed in the event that a plurality of programs are recorded, and a user can thus easily select programs for playback.

However, when storage media having mass storage capacity are used, the number of programs that may be stored is substantial, and selecting a desired program from a program list becomes arduous.

PCT WO 00/02386 discloses a recorded-program viewing support method that facilitates the selection of programs by a user.

Generally, program selection for playback is conducted by displaying the programs as a list in the order in which they were recorded, receiving a program selection from the user, and then playing the selected program. To prevent programs that have been played once from being played again, the distinction between “played” and “unplayed” programs is also displayed in the program list.

However, when the programs include serial episodes and the user selects the latest recorded episode in a serial for playback, the viewing enjoyment for the user will generally be enhanced by firstly playing old “unplayed” episodes recorded prior to the selected episode, if any such episodes exist. Viewing previous episodes after watching the latest episode is likely to greatly reduce the user's enjoyment.

### SUMMARY OF THE INVENTION

In view of the above issues, a first object of the present is to provide a record/playback device and a related computer program that enable playback of a recorded program specified for playback to be deferred, when the specified program is an episode in a serial and there exists one or more episodes in the serial, recorded prior to the specified program, that remain unplayed.

Here, a “serial” consists of programs (i.e. “serial episodes” or simply “episodes”) having the same title and broadcast at regular intervals from the same broadcast station. Generally, the enjoyment of viewing a serial is reduced by half when previous episodes are viewed after watching the latest episode.

A second object of the present invention is to provide a record/playback device that facilitates program specification when the specification of a program for playback is to be received.

A record/playback device provided to achieve the first object stores a plurality of programs, and includes: a receiving unit operable to receive a specification of one of the stored programs for playback; a judging unit operable to judge whether the specified program is an episode in a serial, and whether any of the other programs is an episode in the serial that was recorded prior to the specified program and that has not been played; and a presentation unit operable to present that there is an unplayed episode, when judged by the judging unit that the specified program is an episode in a serial, and that there is another program which is an episode in the serial recorded prior to the specified program and has not been played.

According to this structure, it is possible to prevent the user's enjoyment from being greatly reduced when a specified program is an episode in a serial, as a result of the user viewing a newly recorded episode first, despite there being one or more unplayed episodes in the serial recorded prior to the specified program.

Here, the record/playback device may further include a storage unit operable to store, for each program, a record-setting item and a playback history, and the judging unit may include an episode judging subunit operable to judge whether the specified program is an episode in a serial, based on the record-setting item, and a playback judging subunit operable to judge that there is an unplayed episode, when a playback history of another program that is an episode in the serial recorded prior to the specified program is “unplayed”.

According to this structure, it can be easily judged whether a specified program is an episode in a serial, and whether there are any unplayed episodes in the serial recorded prior to the specified program.

Here, the record-setting item may include a broadcast channel, a recording date and a recording time, and the episode judging subunit may judge the specified program to be an episode in a serial if another of the programs has (i) the same broadcast channel and recording time as the specified program, and (ii) a recording date seven days prior to a recording date of the specified program.

Here, the record-setting item may include a broadcast channel, a recording date, a recording time and a day-of-the-week, and the episode judging subunit may include a day-of-the-week judging subunit operable to judge the specified program to be an episode in a serial if another of the programs has (i) the same broadcast channel, recording time and day-of-the-week as the specified program, and (ii) a different recording date to the specified program.

According to these structures, it can be accurately judged whether a specified program is an episode in a weekly serial.

Here, the record-setting item may include a broadcast channel, a recording date, a recording time and a day-of-the-week, and the episode judging subunit may include a weekday judging subunit operable to judge the specified program to be an episode in a serial if another of the programs has (i) the same broadcast channel and recording time as the specified program, and (ii) a day-of-the-week that is from Monday to Saturday or Monday to Friday.

According to this structure, it can be accurately judged whether a specified program is an episode in a weekday serial.

Here, the record-setting item may include a serial condition, and the episode judging subunit may include a serial judging subunit operable, when a serial condition of the specified program has been set, to judge the specified program to be an episode in a serial if another of the programs has a serial condition that matches the serial condition of the specified program.

According to this structure, it can be accurately judged whether a specified program is an episode in a serial on the basis of a serial condition set by the user.

Here, the record-setting item may include a program title, and the episode judging subunit may include a title judging subunit operable to judge the specified program to be an episode in a serial if another of the programs has the same program title as the specified program.

According to this structure, it can be accurately judged whether a specified program is an episode in a serial.

Here, the record-setting item may include a broadcast channel, a recording date and a recording time, the record/playback device may further include an electronic program guide receiving unit operable to receive an electronic program guide that has been broadcast, and a title recording unit operable to obtain program titles from the received electronic program guide in accordance with the record-setting item, and to record the obtained program titles, and the episode judging subunit may include a title judging subunit operable to judge the specified program to be an episode in a serial if another of the programs has the same program title as the specified program.

According to this structure, the user is relieved of the trouble of inputting titles.

Here, the title judging subunit may compare a character string of the program titles of the specified program and the other program, and judge the program titles to be the same if a difference between the character strings is at a beginning or an end of the character strings.

According to this structure, it is possible to avoid making a mistaken judgment regarding a serial as a result of a slight difference in the titles.

Here, the presentation unit may include a selection display subunit operable to display a selection screen for selecting to play one of the unplayed episode and the specified program, the receiving unit may include a selection receiving subunit operable to receive a selection, from the displayed selection screen, to play one of the unplayed episode and the specified program, and the record/playback device may further include a playback unit operable to play a program indicated in the selection received by the selection receiving subunit, and to set the playback history of the program to “played” when the playback has ended.

According to this structure, the selection of whether to playback a specified new episode or an old unplayed episode is left up to the user.

Here, the episode judging subunit may count a total number of programs judged to be episodes in the serial, the playback judging subunit may count a number of unplayed episodes in the serial, and the selection display subunit may display, on the selection screen, the total number of episodes and the number of unplayed episodes in the serial.

According to this structure, a user can easily select to view unplayed episodes at a more convenient time when there are a large number of unplayed episodes, or to view unplayed episodes immediately when there are a small number of unplayed episodes.

Here, when the selection received by the selection receiving subunit indicates the unplayed episode, the playback unit may play the specified program after playing the unplayed episode.

According to this structure, the user can watch old unplayed episodes first.

Here, the receiving unit may further include a setting receiving subunit operable to receive a record setting that specifies a broadcast channel, a recording date and a recording time of a program, and a setting storage subunit operable to store the specified broadcast channel, recording date and recording time in a content of a record-setting item, and the record/playback device may further include a recording unit operable to record a program specified by a record-setting item stored in the storage unit, and a recording control unit operable, when the episode judging subunit judges that the program to be recorded by the recording unit is an episode in a serial, and the playback judging subunit judges that a playback history of another episode in the serial is “played”, to control the recording unit to overwrite the episode whose playback history is “played”.

According to this structure, a storage area of a storage unit can be used effectively.

Here, the record/playback device may further include an overwrite prohibiting unit operable, when the episode judging subunit judges that the program to be recorded by the recording unit is an episode in a serial, to prohibit the control, by the recording control unit, that relates to the episode whose playback history is “played”, if all episodes subsequent to and including the first episode in the serial have been recorded and none of the recorded episodes have been erased.

According to this structure, it is possible to prevent episodes in a serial that a user wants to save from being erased.

Here, the record/playback device may further include an output unit operable, when the control relating to the episode whose playback history is “played” is prohibited by the overwrite prohibiting unit, to output all recorded episodes in the serial to an external storage device.

According to this structure, it is possible to store, as one program, episodes in a serial that a user wants to save.

Here, the receiving unit may further includes a setting receiving subunit operable to receive a record setting that specifies a broadcast channel, a recording date and a recording time of a program, and a setting storage subunit operable to store a list showing the specified broadcast channel and recording time, and a day-of-the-week table, and the record/playback device may further include an episode inferring unit operable, when there are no programs whose broadcast channel and recording time matches the broadcast channel and recording time shown in the list, to infer that the program is an episode in a serial having a serial condition set to “daily”, and to store the serial condition in the list, and a learning unit operable (i) to discard the inference by the episode inferring unit that the serial condition of the program is “daily” and infer that the serial condition of the program is “weekly”, if the setting receiving subunit does not receive a record setting that specifies the same broadcast channel and recording time as the program and a day-of-the-week that is at least one day from Monday to Friday or Monday to Saturday, and (ii) to discard the inference that the serial condition of the program is “weekly” and update the list to show that the program is not an episode in a serial, if the setting receiving subunit does not receive a record setting that specifies the same broadcast channel, recording time and day-of-the-week as the program.

According to this structure, it can be judged whether a specified program is an episode in a serial on the basis of a content of a record setting made by a user.

Here, the record/playback device may further include a recording unit operable, after the updating of the list by the learning unit has been conducted for a predetermined period of time, to record a program whose record setting has been received by the setting receiving subunit, and to record a program inferred from the list to be an episode in a serial even if the setting receiving subunit has not received a record setting for the program.

According to this structure, a program that is an episode in a serial can be recorded, even if the user forgets to make a record setting.

Here, the record/playback device may further include a priority control unit operable to control the recording unit to prioritize a record setting received by the setting receiving subunit, if the received record setting overlaps with a recording time of the program inferred from the list to be an episode in a serial, and the learning unit may update the list to show the program inferred from the list to be an episode in a serial, as not being an episode in a serial.

According to this structure, in the event that the record/playback device mistakenly judges a program to be a serial episode, priority is given to a manual user operation, and a program specified by the user is recorded.

Here, the record/playback device may further include a playback unit operable, when the presentation unit presents that there is an unplayed episode, to play the unplayed episode, and then play the specified program.

According to this structure, the user's enjoyment is enhanced when a specified program is an episode in a serial and there are one or more old unplayed episodes, by playing the old episodes first.

The second object of the present invention can be achieved by the receiving unit including a display-instruction receiving subunit operable to receive an instruction to display a list showing the stored programs, and the record/playback device further including a storage unit operable to store, for each program, a record-setting item and a playback history, a program judging unit operable to judge, for each program, whether the program is an episode in a serial, based on the record-setting item, and a display unit operable to display, as a single program in a list, all programs judged by the program judging unit to be episodes structuring the serial, and to display, when the receiving unit receives a specification of a program and the specified program is an episode in the serial, the list and a list detail that shows the episodes structuring the serial.

According to this structure, a user can easily make program selections from a large number of programs because episodes in the same serial are displayed in a list as a single program.

The first object can also be achieved by a computer program, applied by a record/playback device storing a plurality of programs, the computer program including: a receiving step of receiving a specification of one of the stored programs for playback; a judging step of judging whether the specified program is an episode in a serial, and whether any of the other programs is an episode in the serial that was recorded prior to the specified program and that has not been played; and a presenting step of presenting that there is an unplayed episode, when judged in the judging step that the specified program is an episode in a serial, and that there is another program which is an episode in the serial recorded prior to the specified program and has not been played.

By applying a computer program such as this to a recording/playback device, it is possible to prevent the user's enjoyment from being greatly reduced when a specified program is an episode in a serial, due to the user viewing a newly recorded episode first, despite there being one or more unplayed episodes in the serial recorded prior to the specified program.

### BRIEF DESCRIPTION OF THE DRAWINGS

These and other objects, advantages and features of the invention will become apparent from the following description thereof taken in conjunction with the accompanying drawings that illustrate specific embodiments of the present invention.

In the drawings:

FIG. 1 is a hardware structural view of an embodiment 1 of a record/playback device according to the present invention;

FIG. 2 is a main structural view of embodiment 1;

FIG. 3 shows an exemplary structure of program data stored on a disk device of embodiment 1;

FIG. 4 shows an exemplary content of record-setting items stored in a setting-item storage unit of embodiment 1;

FIG. 5 shows an exemplary program list displayed on a television screen by a display control unit of embodiment 1;

FIG. 6 shows an exemplary presentation screen displayed on a television screen by the display control unit of embodiment 1;

FIG. 7 shows another example of the presentation screen;

FIG. 8 is a flowchart depicting a playback operation of embodiment 1;

FIG. 9 shows a further example of the presentation screen displayed on a television screen by the display control unit of embodiment 1;

FIG. 10 is a structural view of an embodiment 2 of the record/playback device of the present invention;

FIG. 11 shows an exemplary serial condition table stored in a serial inferring unit of embodiment 2;

FIG. 12 shows an exemplary recording list on the day that the list was created by the serial inferring unit of embodiment 2;

FIG. 13 shows the exemplary recording list on the day after the list was created;

FIG. 14 shows the exemplary recording list on the second day after the list was created;

FIG. 15 shows the exemplary recording list one week after the list was created;

FIG. 16 shows the exemplary recording list one week and one day after the list was created;

FIG. 17 is a flowchart depicting an operation of the serial inferring unit of embodiment 2;

FIG. 18 is a flowchart depicting an operation of a learning unit of embodiment 2;

FIG. 19 shows an exemplary program list displayed on a television screen by a display control unit of an embodiment 3 of the record/playback device according to the present invention; and

FIG. 20 shows a program detail displayed by the display control unit of embodiment 3 together with a program list.

### DETAILED DESCRIPTION OF THE PREFERRED EMBODIMENTS

The embodiments of a record/playback device according to the present invention will now be described with reference to the drawings.

Embodiment 1

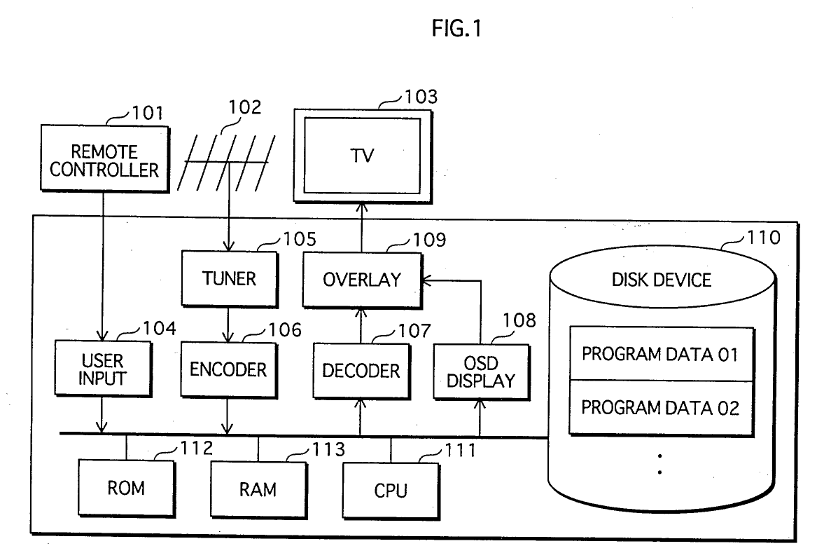

FIG. 1 is a hardware structural view of an embodiment 1 of the record/playback device according to the present invention.

As shown in FIG. 1, the record/playback device includes a user input unit 104 for receiving a user operation from a remote controller 101 or the like, a tuner 105 for receiving from an antenna 102 a television broadcast that uses radio waves, an encoder 106 for converting audio and video from antenna 105 to an MPEG2 format for storing on a disk, a decoder 107 for converting MPEG2 format data stored on a disk to audio/video for display on a television 103, an OSD (on-screen display) display unit 108 for displaying, on a screen for the user, a present state of the record/playback device, an overlay 109 for synthesizing video from decoder 107 with OSD display from OSD display unit 108, a disk device 110 for storing program data, a CPU 111 for controlling the record/playback device, a ROM 112 used to store computer programs for controlling the record/playback device, and a RAM 113 used as a working memory for CPU 111.

Here, when a TV program (hereafter “program”) received by tuner 105 is an MPEG2 format signal, the received program is outputted directly from tuner 105 to a bus 114, without passing through encoder 106.

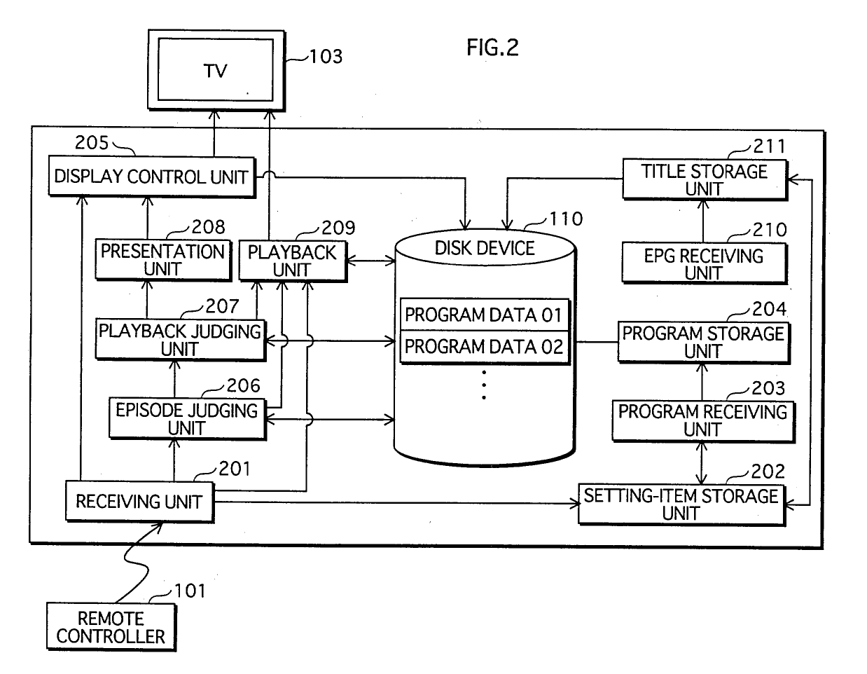

FIG. 2 is a structural view of a main function of the present embodiment realized by a control computer program of CPU 111. Other elements may, of course, be included as the record/playback device.

As shown in FIG. 2, the record/playback device includes disk device 110, a receiving unit 201, a setting-item storage unit 202, a program receiving unit 203, a program storage unit 204, a display control unit 205, an episode judging unit 206, a playback judging unit. 207, a presentation unit 208, a playback unit 209, an EPG (electronic program guide) receiving unit 210, and a title storage unit 211. Receiving unit 201 receives a signal from remote controller 101, which itself receives user operations. Display control unit 205 and playback unit 209 are connected to TV 103.

Disk device 110 is formed from a DVD-RAM recorder, a DVD-RW recorder, a hard disk recorder, and the like. Disk device 110 has a mass-storage storage medium, and stores a plurality of TV programs. Each program includes a content of a record-setting item relating to a record setting of the program, and a playback history.

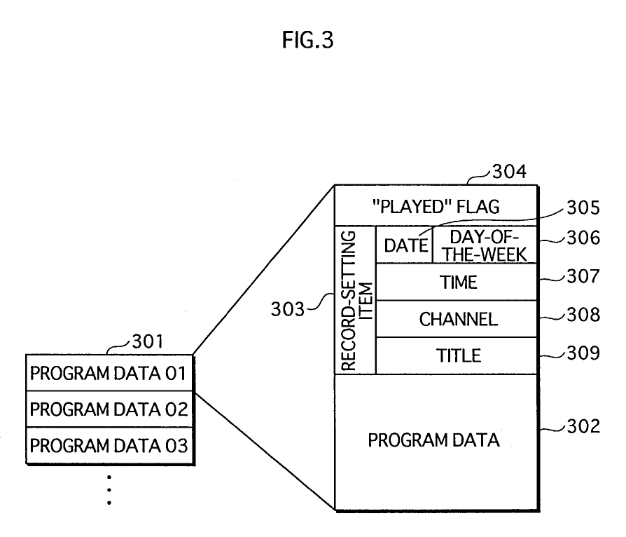

FIG. 3 shows a structure of program data stored on disk device 110.

Program data 301 includes main program data 302, a record-setting item 303 and a playback history 304 of MPEG2 format programs.

Record-setting item 303 includes a date 305, a day-of-the-week 306, a time 307, a channel 303 and a program title 309. Here, “year” is also included in date 305.

Receiving unit 201 receives an operation signal as the result of a user operation of remote controller 101.

When an operation signal for a record setting if received, receiving unit 201 notifies setting-item storage unit 202 and display control unit 205 of a content of the received operation signal.

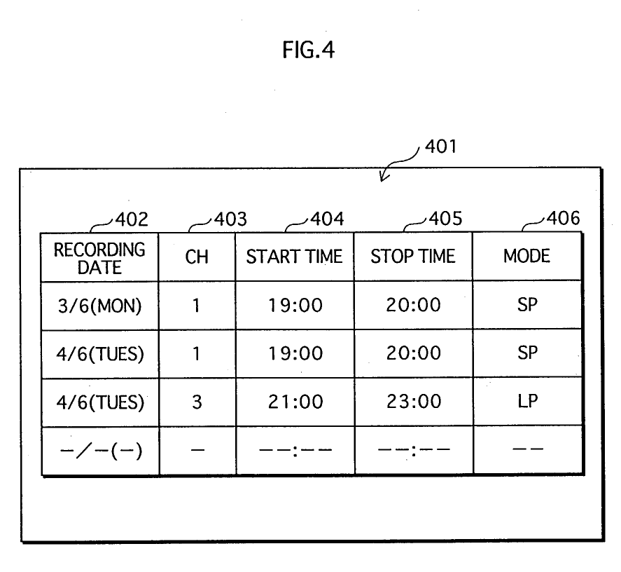

FIG. 4 shows exemplary record-setting items indicating a content of record settings displayed on TV 103 by display control unit 205. Here, “program title” may be added to the input content by a button operation of remote controller 101.

Record-setting item 401 includes a recording date 402, a channel 403, a start time 404, a stop time 405, and a mode 406.

Recording date 402 shows “day” and “month” respectively on either side of a slash mark (e.g. “3/6”=June 3), and “day-of-the-week” is shown in brackets (e.g. “(Monday)” or simply “(Mon)”). Although not displayed in recording date 402, “year” is also inputted.

Channel 403 shows channels on which the programs are broadcast.

Start time 404 is the time from which a program is broadcast, and is therefore the start time of the recording. Stop time 405 is the time at which the recording is to be ended.

Mode 406 shows the quality of the recording mode. “SP” indicates a normal standard-play mode, and “LP” indicates a long-play mode. High image quality is indicated by “HQ”.

When an operation signal resulting from the operation of a list display button of remote controller 101 is received, receiving unit 201 instructs display control unit 205 to display a program list (i.e. a list of recorded program).

When an operation signal specifying a program for playback based on the displayed list of recorded programs is received, receiving unit 201 notifies a content of the record-setting item of the specified program to episode judging unit 206.

When a signal indicating “YES” 602 is received from a user who is viewing presentation screen 601 (described below), receiving unit 201 instructs playback unit 209 to playback the specified program. When a signal indicating “NO” 603 is received, receiving unit 201 instructs display control unit 205 to again display the program list.

Here, when “NO” 603 is indicated, receiving unit 201 may, for example, instruct playback unit 209 to playback last week's unplayed program followed by this week's program.

Setting-item storage unit 202 stores, in a storage area of unit 202, a content of record-setting items notified by receiving unit 201.

When a start time on a recording date of a record-setting item stored in setting-item storage unit 202 is reached, program receiving unit 203 receives a specified channel of the program, performs a predetermined data conversion to make the program data storable on disk device 110, and notifies program storage unit 204 of a content of the converted program data. At this time, program receiving unit 203 also notifies program storage unit 204 of a content of the record-setting item.

When notified by program receiving unit 203 of the content of the record-setting item and the program data, program storage unit 204 stores the notified record-setting item and program data on disk device 110. At this time, a playback history showing “unplayed” is stored as “unplayed”.

An exemplary structure of program data stored on disk device 110 by program storage unit 204 is shown in FIG. 3.

When an instruction to display a program list is received from receiving unit 201, display control unit 205 reads a content of record-setting item 303 and playback history 304 of programs stored on disk device 110, and displays a program list on a screen of TV 103.

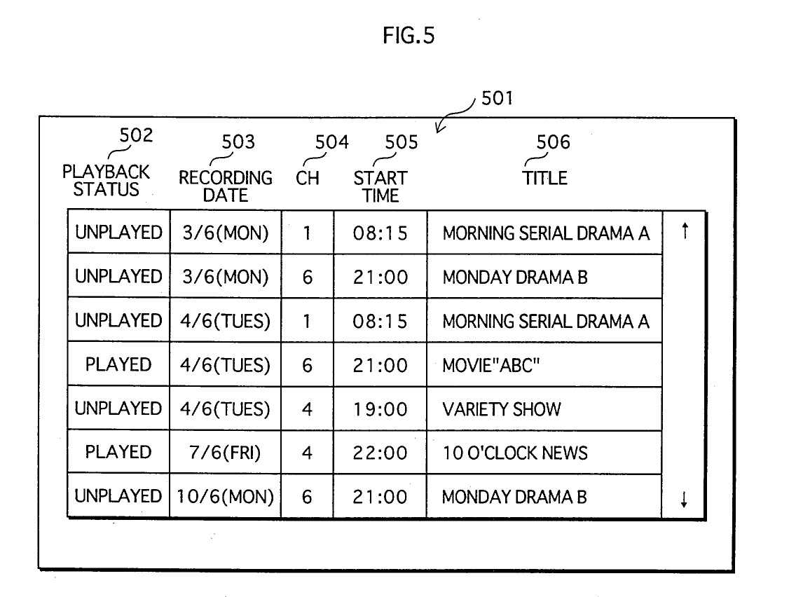

FIG. 5 shows an exemplary program list displayed on TV 103.

Program list 501 specifies recorded programs by a content of the record-setting items.

Displayed in program list 501 is a content of a playback history 502, a recording date (day-of-the-week) 503, a channel 504, a start time 505, and a title 506.

A user selects a program for playback from program list 501.

Here, when a title is not inputted by a user or obtained from an EPG (described below), title 506 in program list 501 is not displayed.

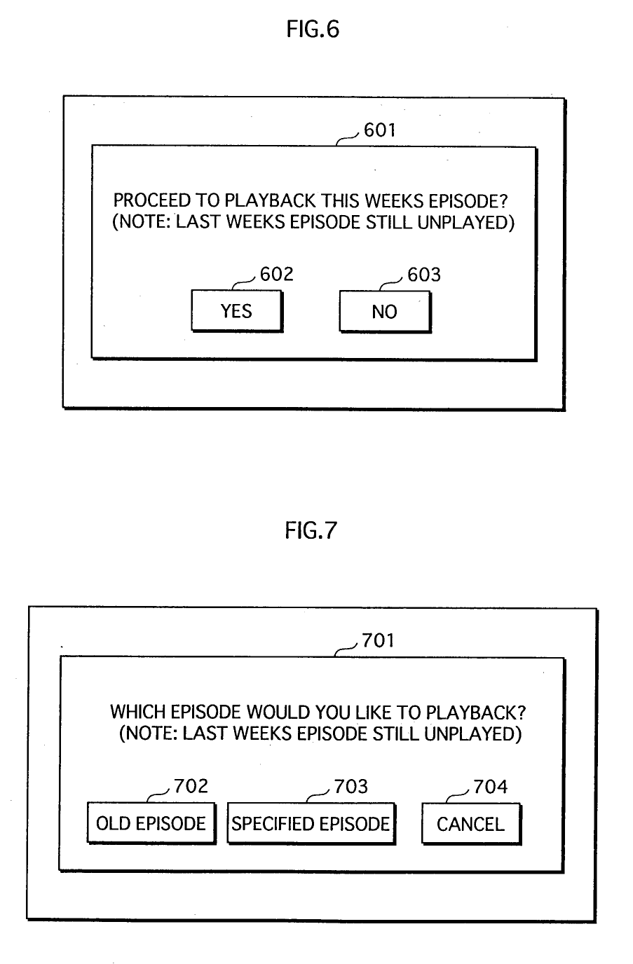

When a program specified for playback by presentation unit 208 is an episode in a serial, and there are one or more other episodes in the serial that were recorded prior to the specified program and remain unplayed, display control unit 205 displays a presentation screen, such as in FIG. 6, on TV 103 when instructed to display a screen presenting that there is an unplayed episode.

When, for example, the playback of this week's episode is specified, presentation screen 601 informs the user that the episode recorded last week has not been played. If the user instructs “YES” 602, the specified program is played. If the user instructs “NO” 603, playback of the specified program is deferred.

Furthermore, instead of the presentation screen in FIG. 6, display control unit 205 may display a presentation screen as shown in FIG. 7. Since last week's episode and this week's episode are both unplayed, presentation screen 701 allows the user to choose which episode to playback.

Here, when receiving unit 201 receives a remote controller signal indicating that the user has selected “old episode” 702, receiving unit 201 instructs playback unit 209 to playback last week's episode first. Receiving unit 201 may instruct playback unit 209 to playback this week's episode following the playback last week's episode.

When a remote controller signal indicating that the user has selected “specified episode” 703 is received, receiving unit 201 instructs playback unit 209 to playback the specified episode.

If “cancel” 704 is selected, receiving unit 201 instructs display control unit 205 to again display the program list.

Episode judging unit 206 compares a content of the record-setting item of each program, and judges whether there are any programs (i.e. episodes) that belong to the same serial. The following principles are applied in the judgment rules:

(1) Programs having the same broadcast channel and recording time, and recorded at a recording-date interval of seven days are judged to be episodes in the same serial.

(2) Programs having the same broadcast channel, recording time, and day-of-the-week are judged to be episodes in the same serial. This rule is the same as (1) above, and can be applied when “day-of-the-week” is included in the record-setting item.

(3) Programs having the same broadcast channel and recording time, and a day-of-the-week showing Monday to Saturday, Monday to Friday, or Monday to Thursday are judged to be episodes in a weekday serial.

(4) When a serial condition, such as “daily”, “weekly”, “Monday to Friday” or the like is set in the record-setting item, programs having matching serial conditions are judged to be episodes in the same serial.

(5) When a program title is included in the record-setting item, programs having the same title are judged to be episodes in the same serial.

There is an exception to rule (5), according to which programs are judged to be episodes in the same serial, even if there are slight differences in the characters or character strings of the titles (e.g. “new”, etc. at the beginning of a title to show that the program is the newest or latest episode in a serial, or “one” “two” etc. at the end of a title to show the sequence of episodes in a serial).

When notified by receiving unit 201 of the content of a record-setting item of a program specified for playback, episode judging unit 206 reads a content of the record-setting item of the programs stored on disk device 110, and judges according to the above rules whether the specified program is an episode in a serial.

If judged to be an episode in a serial, episode judging unit 206 specifies the program and notifies playback judging unit 207. If judged not to be an episode in a serial, episode judging unit 206 instructs playback unit 209 to playback the specified program.

Playback judging unit 207 refers to the playback history of the notified program stored on disk device 110, and judges whether the playback history shows “played” or “unplayed”. If a “played” flag is not set, playback judging unit 207 notifies presentation unit 208 that the program is an episode in a serial and has not been played.

Furthermore, if a “played” flag is set for all of the programs notified by episode judging unit 206 as being episodes in the same serial, this shows that there are no unplayed episodes, and thus playback judging unit 207 instructs playback unit 209 to playback the specified program.

For example, if the programs shown in program list 501 in FIG. 5 are stored on disk device 110, and the program (bottom of list 501) having a recording date of “10/6(Mon)”, a channel of “6” and a start time of “21:00” is specified as the program that the user wants to playback, episode judging unit 206 judges, according to one of rules (1), (2) and (5) above, that the program (second from top of list 501) having a recording date of “3/6(Mon)”, a channel of “6” and a start time of “21:00” is an episode in the same serial.

Furthermore, since the playback history of this program shows “unplayed”, playback judging unit 207 judges the program to have not been played, and notifies presentation unit 208.

When notified by playback judging unit 207 that the specified program is an episode in a serial, and that there is an unplayed episode in the serial recorded prior to the specified program, presentation unit 208 has display control unit 205 display one of presentation screens 601 and 701 shown in FIGS. 6 and 7 as a dialog box on TV 103.

When instructed by one of receiving unit 201, episode judging unit 206, and playback judging 207 to playback a program specified by a user, or a program that is an episode in a serial recorded prior to the specified program, playback unit 209 reads the main program data of the program from disk device 110, conducts data conversion, and outputs the converted program data to TV 103. When playback is completed, a “played” flag is set in the playback history of the program. Here, a “played” flag may be set when playback of a program is started.

EPG receiving unit 210 receives an EPG (electronic program guide) that is broadcast together with programs, and stores the received EPG.

Title storage unit 211 extracts from the EPG a title of a program matching the content of a record-setting item stored in setting-item storage unit 202, and when the program data of the program is stored on disk device 110, title storage unit 211 stores the program title as a content of the record-setting item.

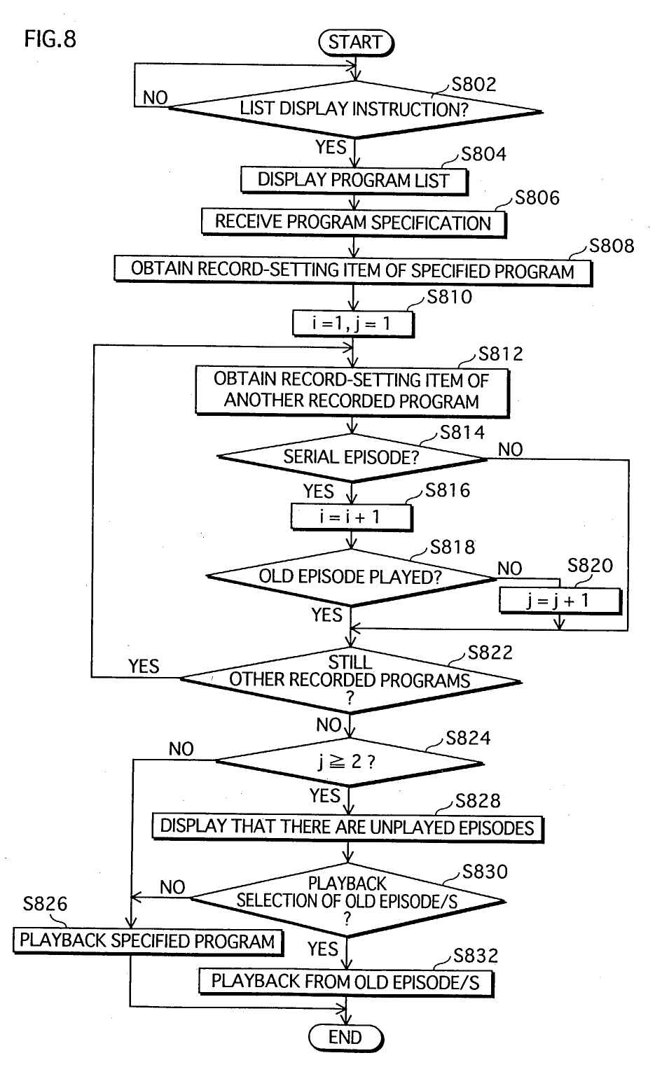

A program playback operation of the present embodiment will now be described with reference to the flowchart in FIG. 8.

Display control unit 205 waits for a list-display instruction from a user via receiving unit 201 (S802), and displays program list 501 on TV 103 (S804).

Receiving unit 201 receives a specification of a program for playback from the user (S806).

Episode judging unit 206 obtains a record-setting item of the specified program (S808).

Episode judging unit 206 initializes a value of a counter i for counting a total number of episodes in a serial to “1”, and playback judging unit 207 initializes a value of a counter j for counting a number of unplayed episodes in the serial to “1” (S810).

Episode judging unit 206 then obtains the record-setting item of another program stored on disk device 110 (S812), and judges whether the specified program is an episode in a serial in accordance with judgment rules (1) to (5) describe above (S814). If judged not to be an episode in a serial (S814=NO), then step S822.

If judged to be an episode in a serial (S814=YES), then “1” is added to counter i (S816).

Playback judging unit 207 then judges whether the old episode recorded prior the specified program has been played, based on the playback history of the old episode (S818). If judged to have been played (S818=YES), then step S822, and if judged not to have been played (S818=NO), then “1” is added to counter j (S820).

In step S822, episode judging unit 206 judges whether there is yet another program recorded prior to the specified program, and returns to step S812 if judged that there is (S822=YES).

If judged that there is not (S822=NO), then playback judging unit 207 judges whether the value of counter j is greater than or equal to “2” (S824).

If judged to be less than “2” (S824=NO), playback unit 209 plays the specified program (S826), and ends the processing.

If judged to be greater than or equal to “2” (S824=YES), presentation unit 208 notifies display control unit 205 to inform the user that there are unplayed serial episodes, and display control unit 205 displays a presentation screen on the screen of TV 103 (S828).

Receiving unit 201 judges whether there is a playback selection of an old episode from the user (S830). If judged that there is not (S830=NO), then S826, and if judged that there is (S830=YES), receiving unit 201 instructs playback unit 209 to playback the old episode.

Playback unit 209 plays the old episode first, followed by the specified program, then sets a “played” flag in the playback history of the programs (S832), and ends the processing.

Here, the record-setting items are sorted in the order in which the programs were recorded, and determine whether a program recorded prior to the specified program is an episode in the same serial.

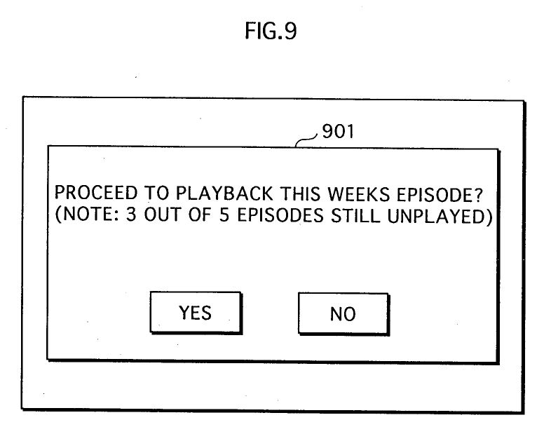

In the above embodiment, presentation screens 601 and 701 only show that there is an old unplayed episode in a serial. However, as shown in FIG. 9, a presentation screen may show the total number of episodes in a serial and the number of unplayed episodes in the serial. Presentation screen 901 shows the total number of episodes as being “5” and the number of unplayed episodes, including the specified program, as being “3”. Moreover, the “total number” and the “unplayed number” are counters i and j, respectively, as described in the FIG. 8 flowchart. By showing the number of unplayed episodes in this way, a user can, if desired, playback the unplayed episodes consecutively, even if there are many unplayed episodes, or the user may choose to playback the unplayed episodes at a later date if pressed for time.

Embodiment 2

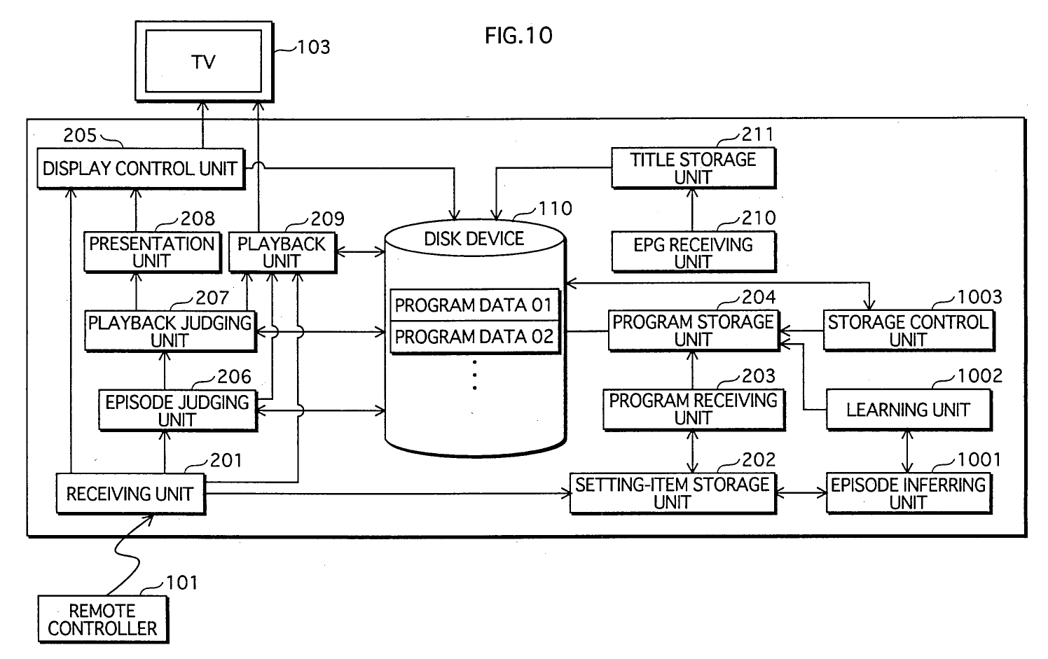

FIG. 10 is a structural view of an embodiment 2 of the record/playback device of the present invention.

In addition to the structure of the record/playback device described in embodiment 1, this record/playback device includes an episode inferring unit 1001, a learning unit 1002, and a storage control unit 1003.

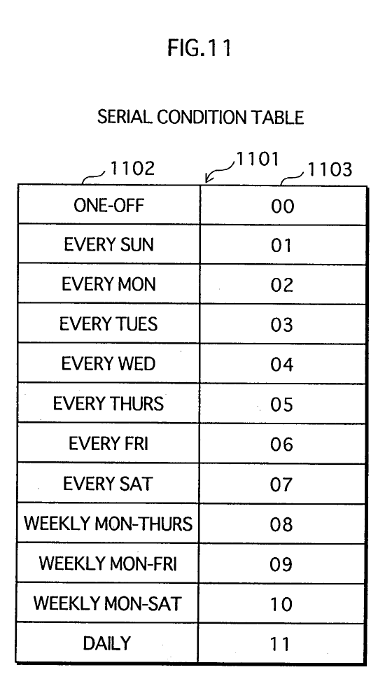

Episode inferring unit 1001 stores a serial condition table such as shown in FIG. 11. Serial condition table 1101 includes identifiers 1103 that correspond respectively to serial conditions 1102. When a recording list (described below) is created, episode inferring unit 1001 attaches identifiers 1103 corresponding to serial conditions 1102.

Serial condition table 1101 includes, as serial conditions 1102, “one-off” indicating that a program is not a serial episode, “every Sun”, “every Mon”, . . . , “Every Sat” indicating that a program is an episode in a weekly serial, “Weekly Mon˜Thurs”, “Weekly Mon˜Fri”, “Weekly Mon˜Sat” indicating that a program is an episode in a weekday serial, or “daily” indicating that a program is an episode in a serial that runs throughout the week, including weekends, public holidays and the like. Identifiers 1103 include the signs “00” to “11” that correspond respectively to the above serial conditions 1102.

Episode inferring unit 1001 obtains the channel, start time and day-of-the-week of the programs from the record-setting items stored in the storage area of setting-item storage unit 202, and creates a recording list.

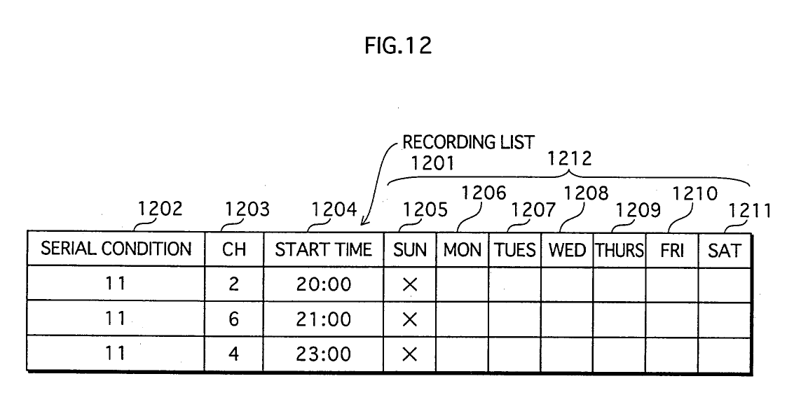

FIG. 12 shows an exemplary recording list on the day that the list was created.

Recording list 1201 shows, for the program in each row, serial condition 1202, channel 1203, start time 1204, and day-of-the-week 1212, all of which relate to the recording of the program. In day-of-the-week 1212, recording days are shown by attaching an “ ” mark, for example, in columns corresponding to “Sun” 1205 to “Sat” 1211 (i.e. Sunday/“Sun” 1205, Monday/“Mon” 1206, Tuesday/“Tues” 1207, Wednesday/“Wed” 1208, Thursday/“Thurs” 1209, Friday/“Fri” 1210, Saturday/“Sat” 1211). Recording list 1201 in FIG. 12 has been created using the obtained recording-setting item content of Sunday programs.

When a record-setting item stored in setting-item storage unit 202 is obtained, episode inferring unit 1001 notifies learning unit 1102, and judges whether there is a program in recording list 1201 having the same channel and start time as the obtained program.

If no such program exists in recording list 1201, episode inferring unit 1001 stores the program with the identifier “11” newly consigned to serial condition 1202.

If a program having the same channel and start time does exist in recording list 1201, episode inferring unit 1001 judges whether serial condition 1202 is satisfied, and if not satisfied, episode inferring unit 1001 stores the program with the identifier “11” newly attached to serial condition 1202. If serial condition 1202 is satisfied, episode inferring unit 1001 attaches an “ ” mark in the corresponding “Sun” column of the recording list.

Learning unit 1002 monitors recording list 1201, and judges, for each program stored in recording list 1201 up until a start time of the program, whether there is notification of a record-setting item that satisfies serial condition 1202 of the program. If there is no such notification, learning unit 1002 updates serial condition 1202 of the program before the elapse of a predetermined time period (e.g. 2 weeks) subsequent to the creation of recording list 1201. The updating of serial condition 1202 involves the rewriting of a broad serial condition into a narrower serial condition. Thus the identifier “11” showing the serial condition “daily” is rewritten to one of identifiers “01” to “07” showing serial conditions “every Mon” to “every Sat”, or one of identifiers “08”, “09” and “10” showing serial conditions “weekly Mon˜Thurs”, “weekly Mon˜Fri” and “weekly Mon˜Sat”. Moreover, identifiers “08” to “10” are rewritten to one of identifiers “02” to “07”, and identifiers “01” to “07” are rewritten to identifier “00” showing that a program is not a serial episode.

Here, if there is notification of a record-setting item that satisfies the serial condition, the program to which the record-setting item relates is recorded by program storage unit 204, as described in embodiment 1.

Learning unit 1002 further judges whether there is notification, from episode inferring unit 1001, of a record setting for another channel at a time that overlaps with the serial condition of the programs in recording list 1201. If there is such a notification, learning unit 1002 updates the serial condition of recording list 1201 to “00”. Program storage unit 204 then prioritizes the notified record setting and records the program to which the notified record setting relates.

If there is no such notification, learning unit 1002 instructs program storage unit 204 to record the programs to satisfy the serial condition. Program storage unit 204 then records the instructed programs. In this way, a serial episode can be recorded, even if the user forgets to make a record setting.

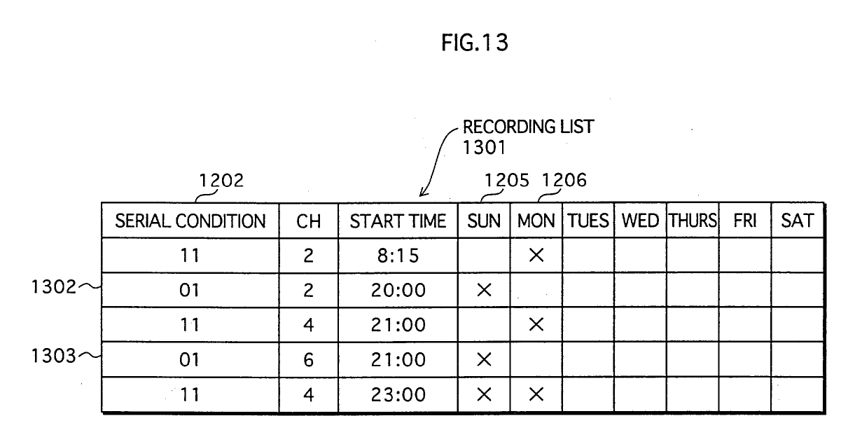

The recording list on the day after the list was created is shown in FIG. 13.

Since a record setting for a program having the same channel and start time as shown in second row 1302 and fourth row 1303 in recording list 1301 has not been made, the serial condition “daily” corresponding to rows 1302 and 1303 is rewritten by learning unit 1002 to the identifier “01” showing “every Sun”. Moreover, for programs with respect to which record-settings have been newly made on Monday, an mark is attached in the column corresponding to “Mon” 1206, and “11” is stored in serial condition 1202.

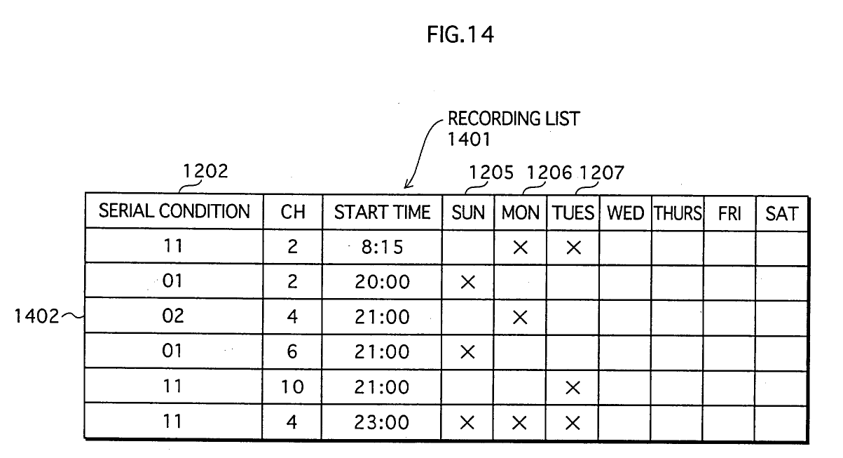

FIG. 14 shows the recording list a further day on. Since a record setting for a program having the same channel and start time as shown in third row 1402 in recording list 1401 has not been made, the corresponding serial condition “daily” is rewritten by learning unit 1002 to the identifier “02” showing “every Mon”.

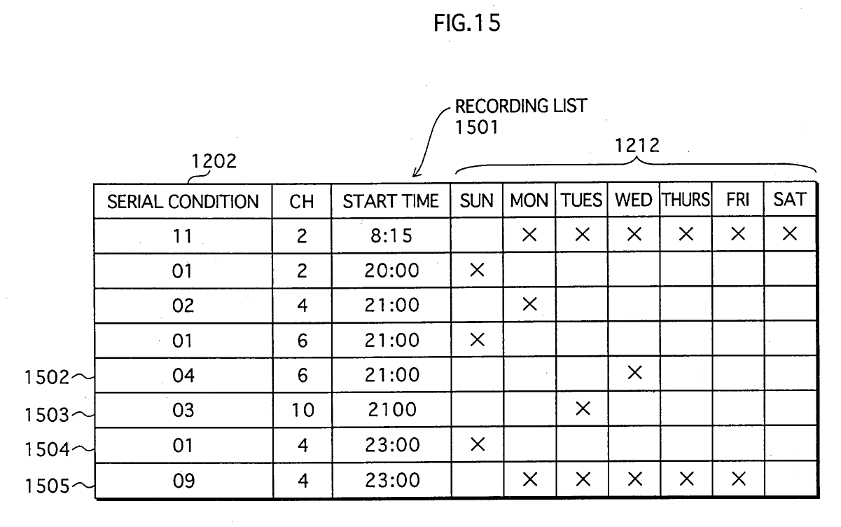

FIG. 15 shows the recording list one week after the list was created.

In recording list 1501, serial conditions 1202 of fifth row 1502 to eighth row 1505 are respectively rewritten by learning unit 1002 to “04” (row 1502), “03” (row 1503), “01” (row 1504), and “09” (row 1505).

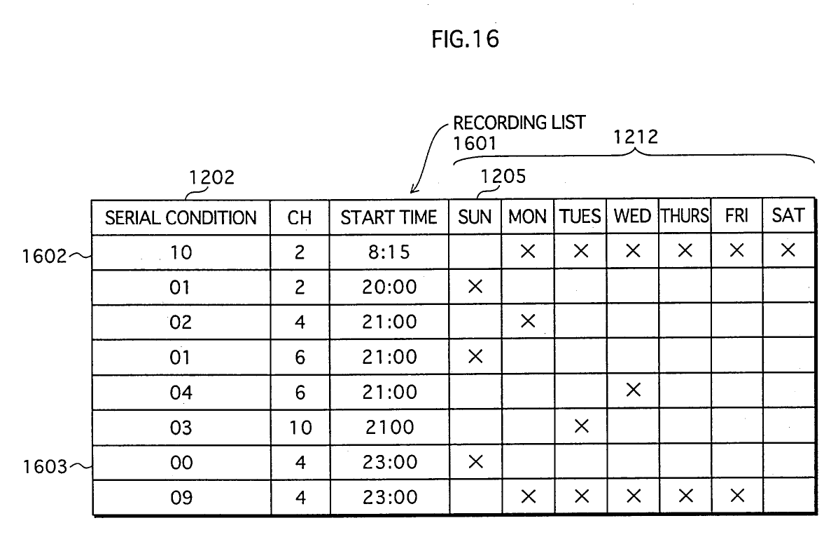

FIG. 16 shows the recording list one week and one day after the list was created. Since a record setting for a program having the same channel and start time as first row 1602 and seventh row 1603 on Sunday week (i.e. eighth day since the creation of the list), the corresponding serial conditions 1202 in recording list 1601 are respectively rewritten by learning unit 1002 to “10” (row 1602) and “00” (row 1603).

When program storage unit 204 stores a program judged by episode judging unit 106 to be a serial episode, or a program that satisfies a serial condition in a recording list of episode inferring unit 1001 after the elapse of a predetermined time period, storage control unit 1003 may, if there is a serial episode on disk device 110 that has already been played, instruct program storage unit 204 to overwrite the program data of the played episode. In this way, the storage area of disk device 110 can be used effectively.

Here, storage control unit 1003 refers to the title of the serial episodes stored on disk device 110, and when judged that all of the episodes from the first episode to the latest episode are stored, storage control unit 1003 prohibits the overwriting of played episode.

Furthermore, recorded episodes in the same serial as the played episode whose overwriting is prohibited may be collected together and outputted to an external storage device (not depicted). In this way, a serial can be saved in complete form, and a user can view all of the episodes in the serial in an organized fashion.

Here, in the present embodiment, episode inferring unit 1001 and learning unit 1002 are included, and the serial condition is updated from user record settings. However, as mentioned in embodiment 1, the judgment of whether or not a program is an episode in a serial may be conducted on the basis of a playback instruction from the user.

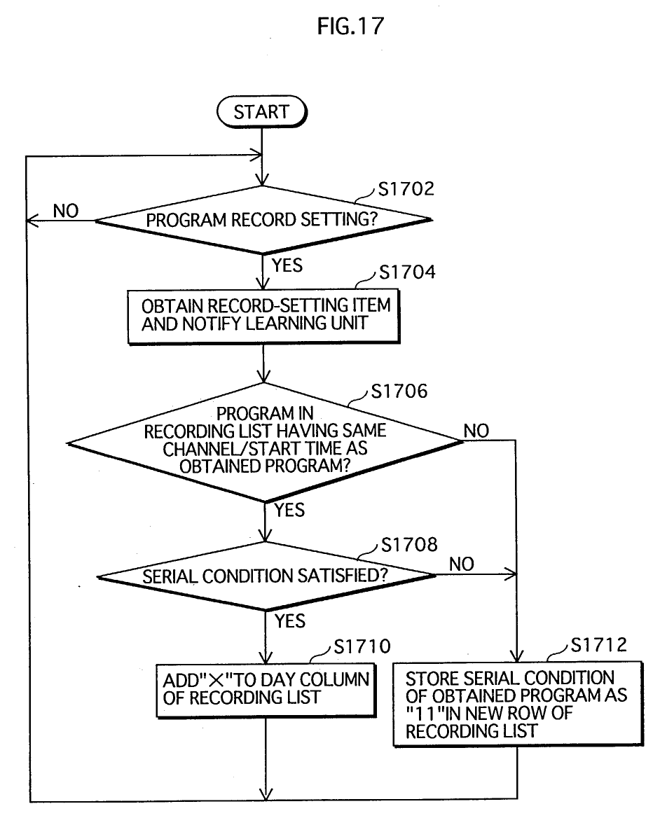

An operation of episode inferring unit 1001 will now be described with reference to the flowchart in FIG. 17.

Episode inferring unit 1001 waits for a content of a record-setting item of a program to be stored in a storage area of setting-item storage unit 202 (S1702), obtains the content of the record-setting item, notifies learning unit 1102 (S1704), and judges whether there is a program in recording list 1201 or the like created by unit 1001 that has the same channel and start time as the obtained program (S1706).

If judged that there is such a program (S1706 YES), episode inferring unit 1001 judges whether a serial condition 1202 is satisfied (S1708), and if judged to be satisfied (S1708=YES), episode inferring unit 1001 consigns an “ ” mark in the day column corresponding to day-of-the-week 1212 in recording list 1201 or the like, and returns to step S1702.

If judged in step S1706 that there is not such program (S1706=NO), or if judged in step S1708 that a serial condition is not satisfied (S1708=NO), episode inferring unit 1001 stores the serial condition of the obtained program in a new row of recording list 1201 or the like as “11” (S1712), and returns to step S1702.

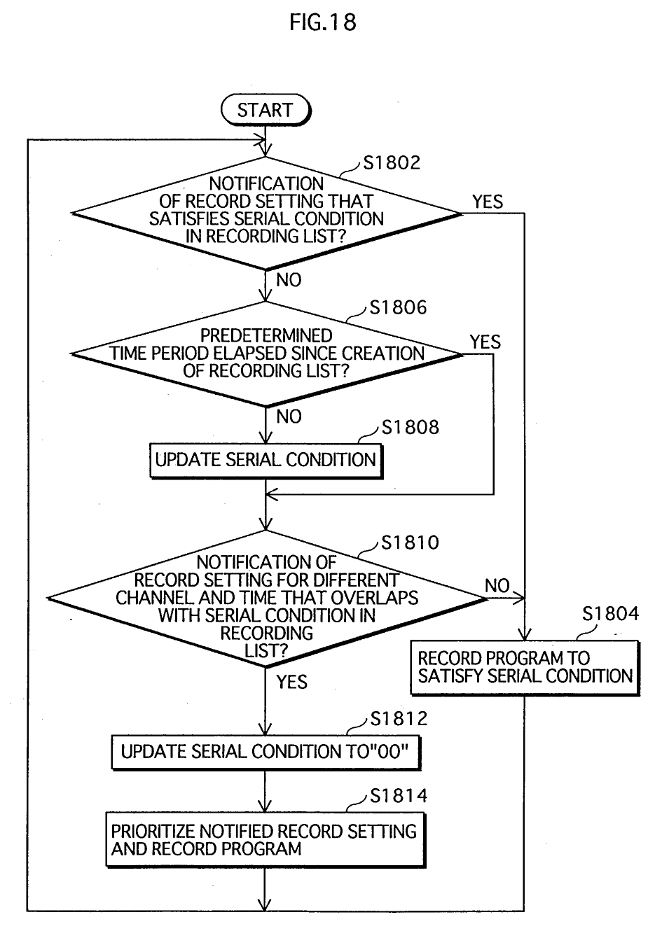

An operation of learning unit 1002 will now be described with reference to the flowchart in FIG. 18.

Learning unit 1002 judges whether a record-setting item content that satisfies a serial condition of a program in recording list 1201 or the like has been notified by episode inferring unit 100 (S1802), and if such a record-setting item content has been notified (S1802=YES), the program data is stored on disk device 110 by program storage unit 204 (S1804) and the processing returns to S1802.

If no such a record-setting item content has been notified (S1802=NO), learning unit 1002 judges whether a predetermined time period has elapsed since the creation of recording list 1201 (S1806), and if judged that the predetermined time period has not elapsed (S1806=NO), learning unit 1002 updates serial condition 1202 of programs in recording list 1201 created by episode inferring unit 1001 (S1808).

On the other hand, if judged that the predetermined time period has elapsed (S1806=YES), learning unit 1002 judges whether there is notification of a record-setting item having a different channel and a start time that overlaps with the serial condition of a program shown in recording list 1201 or the like (S1810), and if judged that there is no such notification (S1810=NO), learning unit 1002 notifies program storage unit 204 of a program whose record setting has not been received, instructs program storage unit 204 to record the program so as to satisfy the serial condition (S1804), and returns to step S1802.

On the other hand, if judged that there is such a notification (S1810=YES), learning unit 1002 updates the serial condition 1202 in recording list 1202 or the like of the program whose start time is overlapped to “00” (S1812).

Program storage unit 204 then prioritizes the notified record setting and records the program to which the notified record setting relates (S1814), and returns to step S1802.

Embodiment 3

An embodiment 3 of the record/playback device according to the present invention will now be described. Since the structure of the present embodiment is substantially the same as the structure of embodiment 1, only parts of the structure unique to the present invention will be described with reference to the FIG. 2 structural diagram.

When an operation signal resulting from the operation of a list display button of remote controller 101 is received, receiving unit 201 instructs episode judging unit 206 to generate a recorded program list.

When instructed by receiving unit 201 to generate a program list, episode judging unit 206 sequentially reads a content of record-setting item 303 (FIG. 3) of programs stored on disk device 110 in the order in which the programs were recorded, and judges whether there are programs that are episodes in the same serial. The judgment rules applied here are the same as those described above in embodiment 1.

When judged that there are episodes in the same serial, episode judging unit 206 stores newly recorded episodes sequentially, so as that they relate to a representative previously recorded episode (i.e. “old episode”). Episode judging unit 206 generates a program list that omits from the display of the program list, episodes that are stored so as to relate to the old episode, and notifies display control unit 205. At this time, episode judging unit 206 consigns a mark in the program list to show that there are related episodes.

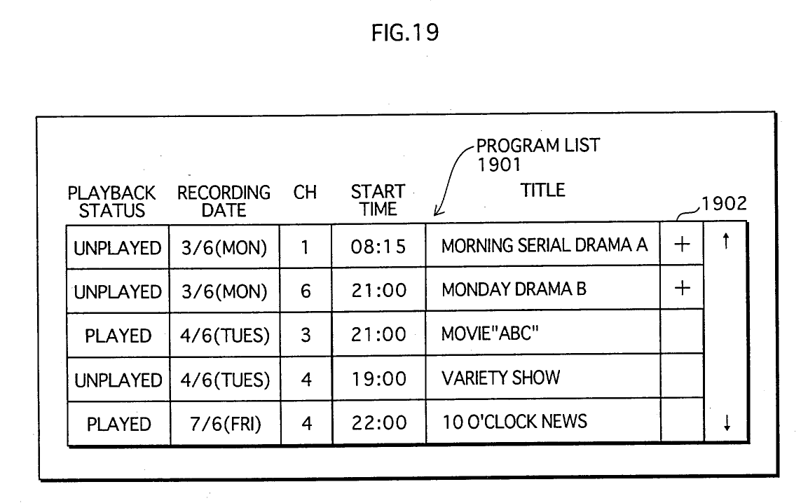

FIG. 19 shows an exemplary program list displayed on TV 103 by display control unit 205. Program list 1901 displays the serial episodes from program list 501 (see FIG. 5) in condensed form, with only a representative episode displayed in the list. Thus the first and third rows of program list 501 are shown collectively in the first row of program list 1901, and the second and seventh rows of program list 501 are shown collectively in the second row of program list 1901.

The “+” mark displayed in column 1902 on the right-hand side of the title column in program list 1901 indicates that episodes in the same serial are displayed in collected form. Thus by displaying serial episodes in condensed form, program list 1901 is simplified, and searching for programs to playback is facilitated.

When the user selects, from program list 1901, the title “Monday drama B” having an “+” mark in column 1902, receiving unit 101 receives a corresponding operation signal, and notifies episode judging unit 206.

Episode judging unit 206 notifies display control unit 205 of stored episodes relating to title “Monday drama B” having a recording date of “3/6 (Mon)”.

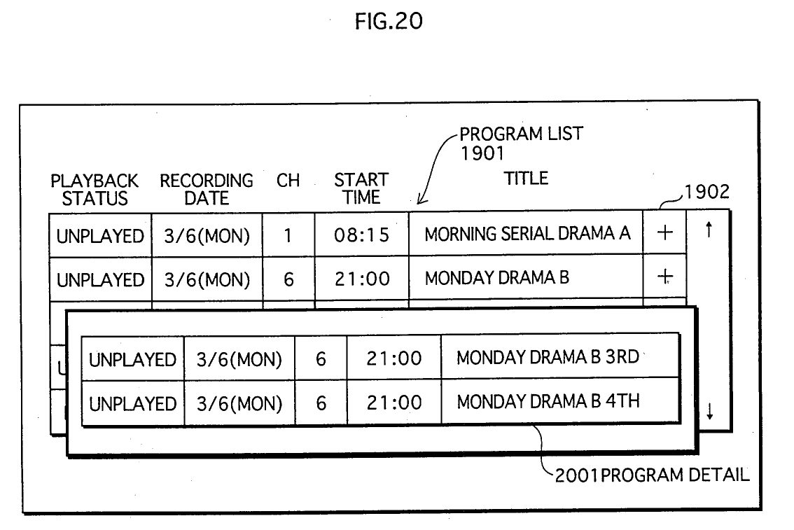

As shown in FIG. 20, display control unit 205 displays a program detail 2001 of “Monday drama B” together with program list 1901.

Program detail 2001 is a list of serial episodes related to title “Monday drama B” having a recording date of “3/6 (Mon)”, and allows the user to easily select which of the episodes to playback.

Here, program detail 2001 displays, in the title column, not only “Monday drama B” but also “3rd” and “4th” showing that the respective episodes are sequentially the third and forth in the serial. The following structure is required to conduct this additional display, and thus “3rd”, “4th” and the like may not necessarily be displayed.

Each program broadcast from a broadcast station has imbedded in a predetermined area of program data 302 (see FIG. 3), information that describes a content of the program. When judged that a program is serial episode, episode judging unit 206 obtains the information from the predetermined area of the program data. In the present embodiment, this information is “3rd”, “4th” and the like. Episode judging unit 206 then adds the obtained information to the program title and notifies display control unit 205.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A record/playback device storing a plurality of programs, comprising:
a receiving unit operable to receive a specification of one of the stored programs for playback;
a judging unit operable to judge whether the specified program is an episode in a serial, and whether any of the other programs is an episode in the serial that was recorded prior to the specified program and that has not been played; and
a presentation unit operable to present that there is an unplayed episode, when judged by the judging unit that the specified program is an episode in a serial, and that there is another program which is an episode in the serial recorded prior to the specified program and has not been played.

2. The record/playback device of claim 1, further comprising:
a storage unit operable to store, for each program, a record-setting item and a playback history, wherein
the judging unit includes:
an episode judging subunit operable to judge whether the specified program is an episode in a serial, based on the record-setting item; and
a playback judging subunit operable to judge that there is an unplayed episode, when a playback history of another program that is an episode in the serial recorded prior to the specified program is “unplayed”.

3. The record/playback device of claim 2, wherein
the record-setting item includes a broadcast channel, a recording date and a recording time, and
the episode judging subunit judges the specified program to be an episode in a serial if another of the programs has (i) the same broadcast channel and recording time as the specified program, and (ii) a recording date seven days prior to a recording date of the specified program.

4. The record/playback device of claim 2, wherein
the record-setting item includes a broadcast channel, a recording date, a recording time and a day-of-the-week, and
the episode judging subunit includes:
a day-of-the-week judging subunit operable to judge the specified program to be an episode in a serial if another of the programs has (i) the same broadcast channel, recording time and day-of-the-week as the specified program, and (ii) a different recording date to the specified program.

5. The record/playback device of claim 2, wherein
the record-setting item includes a broadcast channel, a recording date, a recording time and a day-of-the-week, and
the episode judging subunit includes:
a weekday judging subunit operable to judge the specified program to be an episode in a serial if another of the programs has (i) the same broadcast channel and recording time as the specified program, and (ii) a day-of-the-week that is from Monday to Saturday or Monday to Friday.

6. The record/playback device of claim 2, wherein
the record-setting item includes a serial condition, and
the episode judging subunit includes:
a serial judging subunit operable, when a serial condition of the specified program has been set, to judge the specified program to be an episode in a serial if another of the programs has a serial condition that matches the serial condition of the specified program.

7. The record/playback device of claim 2, wherein
the record-setting item includes a program title, and
the episode judging subunit includes:
a title judging subunit operable to judge the specified program to be an episode in a serial if another of the programs has the same program title as the specified program.

8. The record/playback device of claim 2, wherein
the record-setting item includes a broadcast channel, a recording date and a recording time,
the record/playback device further comprises:
an electronic program guide receiving unit operable to receive an electronic program guide that has been broadcast; and
a title recording unit operable to obtain program titles from the received electronic program guide in accordance with the record-setting item, and to record the obtained program titles, and
the episode judging subunit includes:
a title judging subunit operable to judge the specified program to be an episode in a serial if another of the programs has the same program title as the specified program.

9. The record/playback device of claim 8, wherein
the title judging subunit compares a character string of the program titles of the specified program and the other program, and judges the program titles to be the same if a difference between the character strings is at a beginning or an end of the character strings.

10. The record/playback device of claim 2, wherein
the presentation unit includes:
a selection display subunit operable to display a selection screen for selecting to play one of the unplayed episode and the specified program,
the receiving unit includes:
a selection receiving subunit operable to receive a selection, from the displayed selection screen, to play one of the unplayed episode and the specified program, and
the record/playback device further comprises:
a playback unit operable to play a program indicated in the selection received by the selection receiving subunit, and to set the playback history of the program to “played” when the playback has ended.

11. The record/playback device of claim 10, wherein
the episode judging subunit counts a total number of programs judged to be episodes in the serial,
the playback judging subunit counts a number of unplayed episodes in the serial, and
the selection display subunit displays, on the selection screen, the total number of episodes and the number of unplayed episodes in the serial.

12. The record/playback device of claim 10, wherein
when the selection received by the selection receiving subunit indicates the unplayed episode, the playback unit plays the specified program after playing the unplayed episode.

13. The record/playback device of claim 2, wherein
the receiving unit further includes:
a setting receiving subunit operable to receive a record setting that specifies a broadcast channel, a recording date and a recording time of a program; and
a setting storage subunit operable to store the specified broadcast channel, recording date and recording time in a content of a record-setting item, and
the record/playback device further comprises:
a recording unit operable to record a program specified by a record-setting item stored in the storage unit; and
a recording control unit operable, when the episode judging subunit judges that the program to be recorded by the recording unit is an episode in a serial, and the playback judging subunit judges that a playback history of another episode in the serial is “played”, to control the recording unit to overwrite the episode whose playback history is “played”.

14. The record/playback device of claim 13, further comprising:
an overwrite prohibiting unit operable, when the episode judging subunit judges that the program to be recorded by the recording unit is an episode in a serial, to prohibit the control, by the recording control unit, that relates to the episode whose playback history is “played”, if all episodes subsequent to and including the first episode in the serial have been recorded and none of the recorded episodes have been erased.

15. The record/playback device of claim 14, further comprising:
an output unit operable, when the control relating to the episode whose playback history is “played” is prohibited by the overwrite prohibiting unit, to output all recorded episodes in the serial to an external storage device.

16. The record/playback device of claim 1, wherein
the receiving unit further includes:
a setting receiving subunit operable to receive a record setting that specifies a broadcast channel, a recording date and a recording time of a program; and
a setting storage subunit operable to store a list showing the specified broadcast channel and recording time, and a day-of-the-week table, and
the record/playback device further comprises:
an episode inferring unit operable, when there are no programs whose broadcast channel and recording time matches the broadcast channel and recording time shown in the list, to infer that the program is an episode in a serial having a serial condition set to “daily”, and to store the serial condition in the list; and
a learning unit operable (i) to discard the inference by the episode inferring unit that the serial condition of the program is “daily” and infer that the serial condition of the program is “weekly”, if the setting receiving subunit does not receive a record setting that specifies the same broadcast channel and recording time as the program and a day-of-the-week that is at least one day from Monday to Friday or Monday to Saturday, and (ii) to discard the inference that the serial condition of the program is “weekly” and update the list to show that the program is not an episode in a serial, if the setting receiving subunit does not receive a record setting that specifies the same broadcast channel, recording time and day-of-the-week as the program.

17. The record/playback device of claim 16, further comprising:
a recording unit operable, after the updating of the list by the learning unit has been conducted for a predetermined period of time, to record a program whose record setting has been received by the setting receiving subunit, and to record a program inferred from the list to be an episode in a serial even if the setting receiving subunit has not received a record setting for the program.

18. The record/playback device of claim 17, further comprising:
a priority control unit operable to control the recording unit to prioritize a record setting received by the setting receiving subunit, if the received record setting overlaps with a recording time of the program inferred from the list to be an episode in a serial, wherein
the learning unit updates the list to show the program inferred from the list to be an episode in a serial, as not being an episode in a serial.

19. The record/playback device of claim 1, further comprising:
a playback unit operable, when the presentation unit presents that there is an unplayed episode, to play the unplayed episode, and then play the specified program.

20. The record/playback device of claim 1, wherein
the receiving unit includes:
a display-instruction receiving subunit operable to receive an instruction to display a list showing the stored programs, and
the record/playback device further comprises:
a storage unit operable to store, for each program, a record-setting item and a playback history;
a program judging unit operable to judge, for each program, whether the program is an episode in a serial, based on the record-setting item; and
a display unit operable to display, as a single program in a list, all programs judged by the program judging unit to be episodes structuring the serial, and to display, when the receiving unit receives a specification of a program and the specified program is an episode in the serial, the list and a list detail that shows the episodes structuring the serial.

21. A computer program applied by a record/playback device storing a plurality of programs, comprising:
a receiving step of receiving a specification of one of the stored programs for playback;
a judging step of judging whether the specified program is an episode in a serial, and whether any of the other programs is an episode in the serial that was recorded prior to the specified program and that has not been played; and
a presenting step of presenting that there is an unplayed episode, when judged in the judging step that the specified program is an episode in a serial, and that there is another program which is an episode in the serial recorded prior to the specified program and has not been played.
